(19) United States
(12) Patent Application Publication
(10) Pub. No.: US 2026/0098812 A1
(43) Pub. Date: Apr. 9, 2026

(54) BIOLOGICAL TISSUE ANALYSIS DEVICE AND METHOD

(71) Applicant: ADVANCED OSTEOTOMY TOOLS - AOT AG, Basel (CH)

(72) Inventors: Michael PEYER, Bern (CH); Klaus Olaf BÖRNSEN, Denzlingen (DE); Georgy BODUROV, Basel (CH)

(21) Appl. No.: 19/111,424

(22) PCT Filed: Sep. 29, 2023
(86) PCT No.: PCT/EP2023/077052

§ 371 Date: Mar. 13, 2025

(30) Foreign Application Priority Data
Sep. 30, 2022 (CH) CH001137/2022

(51) Int. Cl. G01N 21/71; G01J 3/443

(52) U.S. Cl. CPC G01N 21/718; G01J 3/443; G01N 2201/0697

(57) ABSTRACT

A biological tissue analysis device to analyze biological tissue by laser induced breakdown spectroscopy comprises a laser generator (1, 2), a spectrometer module (7, 8, 12) and a control unit (5, 6). The laser generator (1, 2) is configured to provide laser beam pulses towards a biological target tissue. The control unit (5, 6) is connected to the laser generator (1, 2) and to the spectrometer module (7, 8, 12). The control unit (5, 6) is configured to operate the laser generator (1, 2) to provide at least one of the laser beam pulses as analysis pulse generating, at a laser pulse time, an analysis plasma comprising a reference element at least in a first excited state and in a second excited state. The spectrometer module (7, 8, 12) is configured to collect, at an acquisition time, emission light of the analysis plasma and to analyze emission lines in the collected emission light. The control unit (5, 6) is configured to keep an emission line relationship between a first emission line of the reference element of the analysis plasma at a first wavelength correlating to the first excited state and a second emission line of the reference element of the analysis plasma at a second wavelength correlating to the second excited state in a predefined reference emission line range.

### TECHNICAL FIELD

The present invention relates to a biological tissue analysis device according to the preamble of independent claim 1 and more particularly to a method of detecting cells or analyzing cell contents of a specific type in a biological target tissue.

Such biological tissue analysis device can be used for automatically analyzing biological tissue by laser induced breakdown spectroscopy. Such device may comprise a laser generator configured to provide laser beam pulses towards a target tissue; a spectrometer module; and a control unit connected to the laser generator and to the spectrometer module. The control unit can be configured to operate the laser generator to provide at least one of the laser beam pulses as analysis pulse generating, at a laser pulse time, an analysis plasma comprising a reference element at least in a first excited state and in a second excited state. The spectrometer module may be configured to collect, at an acquisition time, emission light of the analysis plasma and to analyze emission lines in the collected emission light.

### BACKGROUND ART

Laser Induced Breakdown Spectroscopy (LIBS) is a well-established technology typically used in metalworking or geological areas. In LIBS a short laser pulse (femtosecond to nanosecond) is provided to a surface of a probe, which creates a hot plasma for a comparably short moment. During this time molecules breakdown in their atoms and are electronically excited. In the following, the excited atoms fall down to their ground state and emit their atom characteristic emission light. The emission light of a given sample is collected and analyzed by a spectrometer and usually gathered in emission lines. From these atom specific emissions lines, it is possible to identify the original atom and also to quantify the amount of the respective atom relative to others.

In recent years, it was also attempted to apply LIBS for characterization of biological samples, like plants, leaves, bones and other biological tissues. However, it has turned out that compared to metals and minerals it is much more difficult to apply LIBS on biological tissues. While metals, alloys and stones have a high density, a dry and solid state, biological materials have a much lower density, are less homogeneous and contain substantial amount of water. The low density leads to less signal intensities because the number of molecules and atoms is less. The water content leads to additional loss of signal because the water leads to a lower plasma temperature and, eventually, other quenching effects. Therefore, soft and/or moist materials are often resulting in results of limited quality. Furthermore, as biological tissues typically are comparably inhomogeneous also at a comparably small scale, the plasma plume generated in LIBS may be comparably inhomogeneous. For example, a varying water content may lead to varying temperatures generated when applying the LIBS laser such that plumes with varying composition and conditions are generated over time, when analyzing the biological tissue.

An additional challenge is that the differences in biological samples are often very minor and only advanced statistical methods can observe these differences. For all of this reasons, known LIBS systems are not commonly used for analyzing biological samples. Rather, classical histology preparations of biological tissues obtained by biopsy still are the wide spread and most common way of analyzing biological tissue. However, such procedures are comparably cumbersome and slow. Often these systems need up to hundreds of accumulated spectra to overcome the high variability of the signal intensities from biological tissues.

Since LIBS is beneficial for sample analysis for various reasons such as speed, accuracy and variability, there is a need for a LIBS system allowing an efficient analysis of biological tissue.

### DISCLOSURE OF THE INVENTION

According to the invention this need is settled by a biological tissue analysis device as it is defined by the features of independent claim 1, by a method of detecting cells of a specific type in a biological target tissue as it is defined by the features of independent claim 33, and by a computer program as it is defined by the features of independent claim 62. Preferred embodiments are subject of the dependent claims.

In particular, the invention is a biological tissue analysis device designed to analyze tissue by laser induced breakdown spectroscopy. The device comprises a laser generator, a spectrometer module and a control unit. The laser generator is configured to provide laser beam pulses towards a biological target tissue. The control unit is connected to the laser generator and to the spectrometer module. Such connection particularly relates to a communication connection by which the connected components may communicate. Such connection can be a wired connection or a wireless connection.

The control unit is configured to operate the laser generator to provide at least one of the laser beam pulses as analysis pulse generating, at a laser pulse time, an analysis plasma comprising a reference element at least in a first excited state and in a second excited state. The spectrometer module is configured to collect, at an acquisition time, emission light of the analysis plasma and to analyze emission lines in the collected emission light.

The control unit is configured to keep an emission line relationship between a first emission line of the reference element of the analysis plasma at a first wavelength correlating to the first excited state and a second emission line of the reference element of the analysis plasma at a second wavelength correlating to the second excited state in a predefined reference emission line range.

The term “reference element” as used in connection with the invention relates to a specific or selected element being a species of atoms that have a given number of protons in their nuclei, including the pure substance consisting only of that species. Unlike compounds, elements cannot be broken down into simpler substances by any chemical reaction. However, elements may have different ionizations, i.e., comprise different numbers of electrons.

The reference emission line range can be a predefined range of trust, in which the at least two emission lines of the reference element are targeted. As the plasma generated by the analysis plume cannot directly be controlled, in accordance with the invention the plasma conditions can be analyzed and considered. In particular, data can be collected only from plasma plumes fulfilling a given temperature profile which can efficiently by recognized by the emission lines, e.g., of Ca.

The term “excited state” as used herein relates to an ionization of the reference element. As mentioned, the same element can have different numbers of electrons such that different excited states result. Such different excited states of the same element, i.e. the reference element, correlate to emission lines of different wavelengths or different sets of emission lines.

The device can be designed for on the fly or real-time analysis. For example, the device can be configured to apply a comparably low laser power in order to prevent inappropriately high temperatures hindering an accurate analysis of biological tissue.

The device according to the invention is able to analyze automatedly fresh biopsies or extractions from surgeries for tumor and other changes within a short time or real time. The device is mainly analyzing all intact cells within the volume of laser spot, resulting in the electrolyte composition of the cells themselves. Thereby, within a given tissue (biopsies, tissues taken by surgeries or from in vivo) the device can automatically analyze or identify the tissue mainly by their cell contents or composition. The results can be visualized with optical overlays. CT images or the like to make for example tumor structures visible.

In particular, by automatically keeping the emission line of the reference element in the predefined reference emission line range, it can be achieved that the plasma plume and its properties or characteristics can be held in a homogenous range such that the results of the spectroscopic analysis can reliably be compared and evaluated.

Thereby, due to the comparably high speed of the spectrometric analysis, it can be achieved that the tissue can be characterized on the fly, i.e., allowing readjustment of the next laser shot or pulse. This allows to real time consider information about the tissue in a therapeutic application. For example, when removing cancerous tissue, it can be identified where the limit of the cancerous tissue is such that it can precisely be removed, e.g., by the surgeon.

The control unit may be configured to map a given tissue over a defined area where it is decided about the number of laser shots and on the positions to analyze, e.g., by controlling a xyz-sample stage. In this way it may be ensured that at the end there are enough spectra and data points of sufficient quality. Criteria for such quality may involve a plasma temperature to be within a given range, the spectrum not being saturated, the spectrum or signal not being below a threshold, and no data of air shots.

Moreover, often biological tissues or samples show a huge variability in density and water content. This leads to very different LIBS spectra, even when the tissue type is identical. A bit less water might change the spectra already dramatically. It can also be observed that the plasma temperature may be reduced when there is more water present. All this, leads to LIBS spectra which are difficult to compare and therefore the identification of tumor states or even the identification of different tissues becomes to a challenge. For a quantitative analysis of a given set of elements spectra normalization, or just the ratio of two selected elements becomes an important part of the analysis. In biological samples the concentration changes of biomarkers, for examples over different disease states, are in general very small. Therefore, also in LIBS spectra differences are small and the measurement has to be done without any technical variabilities and as exact as possible.

However, the device according to the invention allows for efficiently identifying cancerous tissue. More specifically, the electrolyte and elemental system (Mg, Fe, K, Na, Ca, CN, etc.) of a healthy cell is changing when the healthy cell converts to a tumor cell. This change has been measured by indirect methods, like Raman and fluorescent microscopy systems. Many tumor cells show a strong increase of potassium. For example, in mandible bone tumor cells the calcium content is reduced, while potassium is increased. Also, other LIBS signals may change during conversion form healthy to the tumor state, like CN. This molecule may create from organic molecules which can contain nitrogen carbon double bonds like some lipids, amino acids or proteins by a none complete molecule breakdown. It should be noted that the biological tissue analysis device of the invention can be built in a way that the formation from CN by the reaction with the ambient air is suppressed or rare.

By the invention direct, fast and independent investigation of tissue probes or biopsies for the fast differentiation of healthy and disease tissue areas of given tissues may be achieved. The intracellular electrolyte content and some minor intercellular electrolytes, can be analyzed.

For example, today the detection of cancer cells within bone tissue samples is still a challenge in pathology. At first the hard bone material has to be slowly resolved without destroying the cells, before the cells themselves become visible after an appropriate staining. This process may take several days to weeks until the patient will know the tumor status and perhaps a new surgery has to be done to remove all remaining tumor cells. Therefore, the surgeon should be able to identify tumor cells quickly in a way the surgery can go on, without any interruption. LIBS is able to analyze the electrolyte and elemental composition of tissue samples. A LIBS imaging (mapping of selected elements) guided the surgeon to further understanding of tumor growth. The invention is also able to differentiate different tissue alternations, like necrotic tissues, fibrotic tissues, cancer tissues and others in more or less real time would make a change for patient health.

In other advantageous applications, the invention allows to identify the tissue treated. For example, in applications of laser ablation of tissue, it can be achieved that it is recognized which type of tissue is ablated on the fly or in real-time. E.g., when ablating bone tissue or cartilage tissue, it can be monitored what type of tissue actually is ablated and an appropriate action can be triggered if a tissue other than intended to be ablated is involved. Like this, it can, e.g., be prevented that other tissue is ablated and a particularly precise ablation can be provided.

For achieving an appropriate sensitivity over the complete spectral range of interest, the biological tissue analysis device advantageously comprises at least one additional spectrometer module. Thereby, each spectrometer module can be optimized for a specific portion of the spectral range of interest.

The biological tissue analysis device according to the invention allows for an analysis on a cell bases. Thus, a comparably accurate analysis can be provided. Further, by keeping the emission light range, emission light or spectrum quality can be ensured to make sure equal conditions keep an on all investigated laser spots.

Further, it is known that in biological tissues laser induced plasma plumes result in a high signal variability. Therefore, statistical comparisons provided generate poor results only. However, in accordance with the invention and its preferred embodiments it may be possible to generate high quality spectra within single analytical laser shots. This can result from i) generation of a homogenous plasma over a larger surface area ii) comparably long delay times for establishing an equilibrium of the light emitting atoms iii) and a light collection system with spectrometer with a comparably high sensitivity to allow for such comparably long delay times, iv) a new automated spectrum quality recognitions system controls the device, and v) cleaning or drying laser pulse(s) can be applied in front of the analytical laser pulse.

Preferably, the control unit is configured to keep the emission line relationship in the predefined reference emission line range by adjusting the laser generator and/or the spectrometer module such that a plasma temperature of the analysis pulse is in a predefined temperature range and such that a plasma density of the analysis pulse is in a predefined density range. Like this, a comparably homogeneous plume can efficiently be generated.

Preferably, the reference element is Calcium (Ca). Alternatively, Natrium (Na) may also work as reference element. Ca is an element typically present in bones and bone ablation typically sets free these elements. Like this, the biological tissue analysis device can particularly be suitable for bone applications such as removal of cancerous bone tissue. Furthermore, these elements have a suitable change in emission line pattern in an appropriate temperature profile. Even though Ca is preferred, particularly, when the target tissue is bone, other elements such as Na may also be suitable, particularly, for other tissue or at other temperature profile. For example, whereas pure Ca emission lines may represent bone (hydroxyapatite), CaO and/or CaOH emission lines may be indicative for cartilage tissue. Bone as hydroxyapatite has only a small amount of hydrate water within its crystal, while soluble Ca ions have a huge hydrate sphere. This hydrate sphere of cartilage may generate in the device according to the invention mainly CaO and CaOH light emission bands or lines, while the bone hydroxyapatite provides more pure narrow Ca atom emission lines. In this way there may a discrimination between both Ca origins be made.

Preferably, the first wavelength is about 393 nanometer (nm) such as, e.g., 393.39 nm or about 396 nm such as, e.g., 396.86 nm, and the second wavelength is about 422 nm such as, e.g., 422.71 nm when the reference element is Ca. The first excited state represented by the first wavelength at about 393 nm or about 396 nm may correspond to double charged Ca. The second excited state represented by the second wavelength at about 422 nm may correspond to single charged Ca. The first wavelength may also be about 589 nm such as, e.g., 589.18 nm and the second wavelength may be about 819 nm such as, e.g., 819.22 nm, when the reference element is Na. Such wavelengths allow for efficiently achieving a comparably homogeneous plume and accurate analysis.

Preferably, the emission line relationship is a ratio between the first emission line and the second emission line. Such ratio allows for providing a comparably precise and reliable predefined reference emission line range.

Thereby, the ratio between the first emission line and the second emission line preferably is a ratio between a sum of the emission lines at the first wavelength of about 393 nm and the second wavelength of about 422 nm, when the reference element is Ca, wherein said ratio preferably is more than 0.6 or more than 0.2 and less than 1. The sums involved can be calculated or determined in various manners. For example, such sum can be calculated by integrating the respective emission line. Involving such sums allows for an efficient and accurate analysis and evaluation.

Advantageously, the control unit is configured to set a delay time being the difference between the acquisition time and the laser pulse time such that a maximum background scattering is reduced below a specific value. Like this, disturbances, e.g., caused by the environment of the tissue can be reduced or eliminated such that a continuum emission is possible. In particular, an unspecific radiation can be achieved.

Advantageously, the control unit is configured to keep a baseline of the spectra as flat as possible. In particular, background scattering may be suppressed by an increasing the delay time.

Preferably, the control unit is configured to keep the emission line relationship in the predefined reference emission line range and/or to eliminate back scattering to allow quantitative analysis of the reference element by adapting a delay time being the difference between the acquisition time and the laser pulse time. By such adaptation, an efficient staying of the emission line relationship in the predefined range can be established.

Thereby, the laser generator preferably is configured to provide a plurality of analysis pulses and wherein the control unit is configured to evaluate the emission line relationship of each one of the plural analysis pulses and to adapt the delay time of subsequent analysis pulses to keep the emission line relationship in the predefined reference emission line range and/or to eliminate back scattering. Such on the fly adaptation allows for providing an ongoing and uninterrupted processing.

The delay time preferably is in a range of about 0.5 microseconds to about 25 microseconds or in a range of about 2 microseconds and 10 microseconds. Such delay times have been proven to be appropriate in most fields of application of the biological tissue analysis device such as in bone or other surgery or in analysis of tissue slides embedded in plastic or paraffin.

The control unit preferably is configured to adapt the delay time in accordance with the reference element and/or back scattering. Like this, the device can be adapted to the specific application and the involvement of an advantageous reference element. Further, the control unit may be configured to adapt the delay time to reduce or to cause a lack of background scattering. Like this, the device can be adapted to the specific application and the involvement of an advantageous tissues or probes.

Preferably, the control unit is configured to keep the emission line relationship in the predefined reference emission line range by adapting a power of the analysis pulse. By such adaptation of the power it can be made sure that the current laser power always provides enough photons to generate a similar plasma electron temperature. It can be provided as an alternative or in addition to adapting the delay time. Like this, a particularly suitable relationship can be upheld throughout a complete procedure.

Preferably, the control unit is configured to keep the emission line relationship in the predefined reference emission line range by adapting an integration time. Again, such adaptation can be provided alternatively or additionally to adapting the delay time and/or the laser power. In this way, upholding a suitable relationship can additionally be improved.

Preferably, the laser generator has a beam directing optics configured to focus the plural laser beam pulses. By means of a suitable optics the laser beam pulses can accurately be configured such that an efficient ablation and/or plume generation is possible.

Thereby, the beam directing optics of the laser generator preferably has an emission lens with a focal length of at least about 50 millimeter (mm), of at least about 400 mm, or in a range of about 150 mm to about 250 mm. The emission lens can be a lens in the more literal sense, i.e., a piece of transparent material with curved sides for concentrating light rays, or another structure suitable to focus the laser beam such as a mirror or the like.

Typical LIBS systems for the analysis of biological tissues have a comparably small laser power, typically 1 to 10 Millijoule (mJ), and a comparably short focus lens (usually less than 100 mm) to provide small spot sizes and high photon densities. But small spot sizes mean also less atoms to excite and resulting in less sensitivity and a more homogeneous plasma. A small size of the plasma plume is producing signals with a large intensity variety, resulting in the need of averaging over a number of laser shots. Often, because of the very high photon density on a small spot size, the high photon flux leads to a breakthrough of air or the ambient gas, which is not sample related any more (number and/or intensities of N and O emission lines). Therefore, sometimes a protection gas, like Argon or He is needed for avoiding these intensive peaks, which is not necessary in accordance with the invention.

The angle between laser and collection optic is also important for the sensitivity (e.g., between 0° and) 15°. The formation of a crater by the laser beam is sending the plasma emission cloud more vertical out of the tissue. This effect becomes stronger, when the crater becomes deeper. However, this effect makes it possible to collect LIBS signals from deeper areas (e.g., approximately 0.01 mm to 3 mm or even more) beyond the surface without signal loss. Also, it is important that the expanding plasma can be followed as long as possible to collect the emission light also after long delay times.

Regarding optics, it is to note that for a LIBS system it is important to have the sample surface always within the focus point of the laser lens. However, tissue samples and biopsies may not have always a planar surface, which leads to a change in the photon density and resulting also in different temperatures and signal intensity variations. Therefore, it is important that the samples surface sees always the same number of photons to create good spectra for comparison.

In this context, by the biological tissue analysis device having an emission lens as defined, a comparably high depth of focus or depth of field can be achieved. The used lens allows for generating a comparably large area and a comparably homogeneous plasma with essentially identical photon density. Further, the use of such lens allows to keep the sample or biological tissue surface within focus since it provides an essentially identical photon density over a comparably long range or distance to sample or biological tissue. Still further, long focal length lenses allow to keep the light emitting and fast-moving shock waves in the focal point or focal space for a comparably long time.

Preferably, the beam directing optics is configured to generate a laser beam or laser beam pulses with a spot diameter in a range of about 0.1 millimeter to about 0.4 millimeter. Such spot diameters allow for efficiently providing a resolution or spot size appropriate for analyzing the tissue. Thereby, averaging by spot size or area can performed in such analysis which allows to efficiently identifying the tissue or structures thereof.

Preferably, the beam directing optics is configured to generate a laser beam with a depth of focus (DoF) of more than 10 millimeter. The DoF can define or refer to double of a Rayleigh length. By means of such beam directing optics a comparably homogeneous beam profile can be achieved.

In specific examples, for spot diameters in a range of 0.1 mm to 0.4 mm und focal lengths in a range of 150 mm to 250 mm the following configurations may be embodied: at 0.1 mm spot diameter and 150 mm focal length 24.4 mm DoF may result; at 0.4 mm spot diameter and 150 mm focal length 30.5 mm DoF may result; at 0.1 mm spot diameter and 250 mm focal length 12.7 mm DoF may result; at 0.4 mm spot diameter and 250 mm focal length 49.7 mm DoF may result.

Such biological tissue analysis device may generate a homogenous beam profile and a low beam divergence. Like this, it is possible to provide a larger target area with an identical photon density. For quantification issues, it may be needed that all cells are treated with the approximately same number of photons. If this can be reached, a comparably large plasma plume after a given delay and background scatter may be extinct and homogenous, and may provide enough emission light for single shot sensitivity.

Preferably, the spectrometer module has a converging lens and the analysis pulse has a focal point, wherein the collective lens of the spectrometer module is arranged in a projection of a conus having its apex at the focal point of the analysis pulse and having a cone angle of less than about 60°, of less than about 35° and preferably of about 11°. The term “projection of a conus” in this connection relates to a conus which may be existing in reality in form of an optical or physical structure. More particularly, the projection of a conus is a virtual conus defining a space in which the lens is arranged. By such arrangement of the lens a high sensitivity of emission light collection can be achieved.

Preferably, the biological tissue analysis device comprises a sound wave sensor configured to record an acoustic shock wave of the analysis pulse provided to the target tissue, wherein the sound wave sensor is connected to the control unit. Such sound wave sensor allows for providing an additional evaluation means improving the analysis of the target tissue. Also, the sound wave sensor allows for determining an exact focal distance since the laser beam pulses generate the loudest sound signals at the focal point. Alternative distance measuring means are also possible for determining the focal distance.

The control unit preferably is configured to receive the recorded acoustic shock wave from the sound wave sensor or data from the alternative distance measuring means and to keep the recorded acoustic shock wave in a shock wave range by adapting a distance between the beam directing optics and the target tissue, by adapting a focal point of the beam directing optics, and/or by adjusting a power of the laser generator. Such involvement of shock wave evaluation allows for providing a further improved plasma plume.

The control unit preferably is configured to position the beam directing optics and the target tissue relative to each other at plural distances, to activate the laser generator to provide at least one analysis pulse at each of the plural distances, to receive the recorded acoustic shock wave from the sound wave sensor for each of the plural distances, and positioning the beam directing optics and the target tissue at the one of the plural distances complying to a selection criterion.

Thereby, the selection criterion preferably is a height of an intensity of the recorded acoustic shockwave. The control unit preferably is configured to determine a quality by an acoustic shock wave from the sound wave sensor. This allows for an efficient evaluation of the quality and/or for signal normalization.

Preferably, the biological tissue analysis device comprises a light collecting optics configured to direct light towards the spectrometer module. The light collecting optics can comprise one or plural converging lenses and/or a reflective collimator, e.g., with a 210 mm lens. By such optics, the light can efficiently be directed to a detector of the spectrometer module or be brought into a fiber (glass fiber) of the spectrometer module. For improved light transition over a sufficient mass range such as, typically, 180 nm to 900 nm, more than one collimator may be used to collect more light or with different coatings. Also, as described above two or more spectrometers may be used, e.g., one for ultraviolet to visible light (UV-VIS) and another one for visible to infrared light (VIS-IR).

Preferably, the spectrometer module is configured to switch on within one nanosecond or less and to switch off within one nanosecond or less. Such spectrometer module allows for a comparably accurate detector gating. Also, it allows for exact laser pulse triggering, which may be important when fast increasing signals have to be measured since large jitter for triggering means high variation in signal intensity. Therefore, exact laser pulse triggering may be important for the quantification of the emission light.

Advantageously, the spectrometer module is a low-resolution spectrometer, e.g., having a resolution of more than 0.2 nm per pixel, and a related detector is configured in a way to be sensitive enough that a single plasma (laser shot) provides enough emission light, also of low abundant elements, for a full and intensive LIBS spectrum.

Preferably, the laser generator comprises a high-power Q-switched Nd:YAG laser. Such laser can allow for efficiently implementing the analysis beams as well as ablation laser pulses such as bone ablation laser pulses. In particular, it may be embodied for fast switching or a Q-switch crystal for slow switching between a preparation laser pulse and an analysis pulse.

Advantageously, the Nd:YAG laser may provide a 1064 nm or a 532 nm laser beam or another laser beam with wavelengths between 200 and 1200 nm with similar power and the described beam profile. Typically, it is important that the tissue can absorb the laser light to create a hot plasma. Thus, the beam profile may be important to create a given photon density to make the usage of long focus lenses possible.

Further, it may be essential that the laser beam has a low divergence and a homogeneous beam profile to provide equal distributions of photons onto a target area. For quantification purposes it may be important that a homogenous plasma plume is generated and that the tissue cells within the laser spot (target) receive the same number of photons.

An issue to consider when measuring or detecting emission lines by means of the spectrometer module is, that the spectral data measured comprise background scattering or background noise. Such background noise may be caused by elements present in the environment such elements in the air. Thereby, the later the analysis plasma is measured or evaluated, the less background noise exists. However, at the meantime, the later the analysis plasma is measured or evaluated, the lower the signal is.

Thus, the spectrometer module comprises a comparably highly sensitive spectrometer such as a gated spectrometer. By means of such spectrometer comparably low signals can be measured which allows for measuring comparably late where no or only limited background noise exists. Further, such spectrometer allows for providing appropriate performance such as speed and accuracy required in many applications of the biological tissue analysis device.

Preferably, the control unit is configured to operate the laser generator to provide at least one of the laser beam pulses as preparation pulse sequence. The preparation pulse sequence can be on comparably long laser pulse or a series of shorter laser pulses. For example, the preparation pulse sequence may be a predefined number of pulses identical to the analysis pulse and preceding the analysis pulse. Such preparation pulse sequence may particularly remove liquid from the target tissue where it is aimed to be hit by the analysis pulse. Further, the preparation pules may provide a certain ablation depth such that the analysis pulse hits the target tissue at a lower layer.

Thereby, a temporal width of the preparation pulse sequence preferably is bigger than a temporal width of the analysis pulse. The temporal width of the analysis pulse may be in a range of femtoseconds (fs) to nanoseconds (ns).

The control unit preferably is configured to operate the laser generator to provide the analysis pulse less than 1 millisecond, less than 1 microsecond, less than 100 nanoseconds or less than 50 nanoseconds after the preparation pulse sequence. Such small time gap allows for preventing that a liquid such as blood and/or water will flow to the spot where the analysis pulse is aimed to hit the target tissue. Moreover, such time gaps allow to achieve that the effect of the preparation is still existing when the analysis pulse is provided. Preferably, the control unit is configured to evaluate spectral data provided by the spectrometer module, wherein evaluation of the spectral data comprises at least one of: (i) discarding spectra having a maximum signal below a predefined value; (ii) discarding spectra saturating the spectrometer module; (iii) discarding spectra associated to air by analyzing emission peak intensities of N, of O, and/or of H, which may stem from photon density breakthrough in front of the sample surface; (iv) discarding spectra generated outside a predefined plasma electron temperature and/or plasma electron density; (v) filtering inappropriate spectra; and (vi) summing up or integrating peak areas of the emission lines.

Each of the listed evaluation steps may improve the results of the analysis of the biological tissue. For example, by summing up or integrating the peak areas, sensitivity of the device can be increased or improved. Most preferably, plural or particularly all of the listed steps are combined in order to achieve best results.

Preferably, the spectrometer module has a spectrometer board, wherein the control unit is embodied on the spectrometer board. The term “board” as used in this context can particularly relate to a printed circuit board (PCB) or printed wiring board (PWB) being a laminated sandwich structure of conductive and insulating layers. Typically, PCBs have two complementary functions. The first is to affix electronic components in designated locations on the outer layers by means of soldering. The second is to provide reliable electrical connections and, as the case may be, also reliable open circuits between components in a controlled manner often referred to as PCB design. Such implementation of the spectrometer module on the board allows to achieve a comparably high performance and fast communication between the control unit and the spectrometer module. Like this, run time analysis of the target tissue can be particularly efficient.

Preferably, the biological tissue analysis device comprises a xyz-stage being configured to support a sample of biological tissue at a predefined position and to move the sample in an x-direction, in a y-direction perpendicular to the x-direction and in a z-direction perpendicular to the x-direction and the y-direction. Such three-dimensionally movable xyz-stage allows for accurately position a sample of the tissue.

In particular, since biological tissues typically have inhomogeneities such as, tumor distributions in tissues, it may be required or beneficial not only to detect the presence of particular cells also their xyz distribution within the tissue itself. Therefore, it may important to have a single shot sensitivity and that every recorded spectrum has an identical quality that statistical methods can quantify the amount of biological cell regulations by mainly their electrolytes. Because of this single shot sensitivity in combination with xyz information obtained via the xyz-stage and a scanning of tissues maps, for example of tumor distributions, can be generated.

In another aspect, the invention is a method of detecting cells of a specific type in a biological target tissue, comprising the steps of: a laser generator providing laser beam pulses towards the target tissue by their elemental composition, wherein at least one of the laser beam pulses is configured as analysis pulse generating, at a laser pulse time, an analysis plasma comprising a reference element at least in a first excited state and in a second excited state; a spectrometer module collecting emission light of the analysis plasma at an acquisition time and analyzing emission lines in the collected emission light; and keeping an emission line relationship between a first emission line of the reference element of the analysis plasma at a first wavelength correlating to the first excited state and a second emission line of the reference element of the analysis plasma at a second wavelength correlating to the second excited state in a predefined reference emission line range.

The method according to the invention and its preferred embodiments described below allow to achieve the effects and benefits of the biological tissue analysis device and its preferred embodiments described above.

In an advantageous application, they may particularly allow for efficiently identifying cancerous tissue. More specifically, the electrolyte and elemental system (Mg, Fe, K, Na, Ca, CN, etc.) of a healthy cell is changing when the healthy cell converts to a tumor cell. This change has been measured by indirect methods, like Raman and fluorescent microscopy systems. Many tumor cells show a strong increase of potassium. For example, in mandible bone tumor cells the calcium content is reduced, while potassium is increased. Also, other LIBS signals may change during conversion form healthy to the tumor state, like CN. This molecule may create from amino acids (proteins) by a none complete molecule breakdown. For example, collagen amino acid sequence is based on 20% of proline and hydroxyproline. For example, a typical change of the collagen may change this proline and hydroxyproline content, resulting in a change of the CN signal. It should be noted that the biological tissue analysis device of the invention can be built in a way that the formation from CN by the reaction with the ambient air is suppressed.

In other advantageous applications, they allow to identify the tissue treated. For example, in applications of laser ablation of tissue it can be achieved that it is recognized which type of tissue is ablated on the fly. E.g., when ablating bone tissue or cartilage, it can be monitored what type of tissue actually is ablated and an appropriate action can be triggered if another tissue is involved. Like this, it can, e.g., be prevented that other tissue is ablated.

Preferably, the emission line relationship is kept in the predefined reference emission line range by adjusting the laser generator and/or the spectrometer module such that a plasma temperature of the analysis pulse is in a predefined temperature range and such that a plasma density of the analysis pulse is in a predefined density range.

Preferably, the reference element is Ca. Preferably, the first wavelength is about 393 nm or about 396 nanometer, and the second wavelength is about 422 nm when the reference element is Ca.

Thereby, the predefined reference emission line range is a ratio between a sum of the emission lines at the first wavelength of about 393 nm or of about 396 nm and the second wavelength of about 422 nm when the reference element is Ca, wherein said ratio preferably is more than 0.6 and less than 1.

Preferably, the emission line relationship is a ratio between the first emission line and the second emission line.

Preferably, the emission line relationship is kept in the predefined reference emission line range and/or to eliminate back scattering to allow quantitative analysis of the reference element by adapting a delay time being the difference between the acquisition time and the laser pulse time.

Thereby, the laser generator preferably provides a plurality of analysis pulses, wherein the emission line relationship of each one of the plural analysis pulses is evaluated and wherein the delay time of subsequent analysis pulses is adapted to keep the emission line relationship in the predefined reference emission line range and/or to eliminate back scattering.

The delay time preferably is in a range of about 0.5 microseconds to about 25 microseconds or in a range of about 2 microseconds and 10 microseconds.

The delay time preferably is adapted in accordance with the reference element and/or with a clean base line within the recorded spectrum to avoid back scattering effects.

Preferably, the emission line relationship is kept in the predefined reference emission line range by adapting a power of the analysis pulse and/or by controlling the laser or delay time as longer delay times also reduce an intensity of the signal.

Preferably, the emission line relationship is kept in the predefined reference emission line range by adapting an integration time.

Preferably, the laser generator focuses the plural laser beam pulses.

Thereby, the plural laser beam pulses preferably have a focal length of at least about 100 mm, of at least about 200 mm, or in a range of about 150 mm to about 250 mm.

Preferably, the beam pulses have a spot diameter in a range of about 0.1 millimeter to about 0.4 millimeter.

Preferably, the beam pulses have a depth of focus of more than 10 millimeter.

Preferably, a sound wave sensor records an acoustic shock wave of the analysis plasma generated by the analysis pulse provided to the target tissue.

Thereby, the method preferably comprises a step of keeping the recorded acoustic shock wave in a shock wave range by adapting a distance between the laser generator and the target tissue, by adapting a focal point of the laser generator or by adjusting a power of the laser generator.

The method preferably comprises; positioning the laser generator and the target tissue relative to each other at plural distances; activating the laser generator to provide at least one analysis pulse at each of the plural distances; the sound wave sensor recording an acoustic shock wave for each of the plural distances; filtering inappropriate spectra; and positioning the laser generator and the target tissue relative to each at the one of the plural distances complying to a selection criterion.

Thereby, the selection criterion preferably is a height of an intensity of the recorded acoustic shockwave.

A quality preferably is determined by an acoustic shock wave from the sound wave sensor.

Preferably, the laser generator comprises a high-power Q-switched Nd:YAG laser.

Preferably, the spectrometer module comprises a gated spectrometer.

Preferably, at least one of the laser beam pulses is provided as preparation pulse sequence.

Thereby, a temporal width of the preparation pulse sequence preferably is bigger than a temporal width of the analysis pulse.

The analysis pulse preferably is provided less than 10 ns after the preparation pulse sequence.

Preferably, spectral data provided by the spectrometer module is evaluated, wherein evaluation of the spectral data comprises at least one of: discarding spectra having a maximum signal below a predefined value; discarding spectra saturating the spectrometer module; discarding spectra associated to air by analyzing emission peak intensities of N, of O, and/or of H; discarding spectra generated outside a predefined plasma electron temperature and/or plasma electron density; and summing up or integrating peak areas of the emission lines.

Preferably, the specific cell type is cancer.

Preferably, the tissue is an extracted tissue such that the method is an ex vivo method.

In a further other aspect, the invention is a computer program comprising instructions which, when the program is executed by a computer, cause the computer to carry out the method or any of its embodiments described above.

The computer program can be a computer program product comprising computer code means configured to control a processor of a computer to implement the computer implemented method or any of its preferred embodiments described above or below when being executed on the computer. Further, there can be provided a computer readable medium comprising instructions which, when executed by a computer, cause the computer to carry out the method or any of its preferred embodiments described above or below. The medium can a storage medium and, for allowing a convenient distribution, a mobile or portable storage medium. Or, for allowing a transfer over the Internet or the like, or for other purposes, there can be provided a data carrier signal carrying the computer program described herein before. The computer program can also be referred to as or comprised by a software.

Such computer program allows for efficiently implementing the method according to the invention or any of its preferred embodiments and, thereby, to achieve the involved effects and benefits.

### BRIEF DESCRIPTION OF THE DRAWINGS

The invention is described in more detail hereinbelow by way of an exemplary embodiment and with reference to the attached drawings, in which:

FIG. 1 shows a schematic view of an embodiment of the biological tissue analysis device according to the invention implementing an embodiment of the method according to the invention;

FIG. 2 shows a diagram of spectrometric emission line signals and continuum emission line signals evolving over time;

FIG. 3 shows a diagram of appropriate evaluated spectra;

FIG. 4 shows a diagram of inappropriate evaluated spectra; and

FIG. 5 shows a diagram of other inappropriate evaluated spectra.

### DESCRIPTION OF EMBODIMENTS

In the following description certain terms are used for reasons of convenience and are not intended to limit the invention. The terms “right”, “left”, “up”. “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description.

In this context, the following applies to the rest of this description: If, in order to clarify the drawings, a figure contains reference signs which are not explained in the directly associated part of the description, then it is referred to previous or following description sections.

Further, for reason of lucidity, if in a drawing not all features of a part are provided with reference signs it is referred to other drawings showing the same part. Like numbers in two or more figures represent the same or similar elements.

In the following table, an overview of a general LIBS process is shown. The LIBS process is based on a number of different reactions, which all are influencing signal intensity.

| | Main Steps in LIBS | Remarks |
|---|---|---|
| 1. | Laser pulse (fs or ns; | Constant photon energy pulse. |
| | wavelength; power) | |
| 2. | Light absorption by | Photon energy transfer to heat, depending on material |
| | target material | properties and water content. |
| | | Formation of plasma shock wave. |
| | | Continuum emission up to 1,000 ns after the laser pule. |
| | | Inhomogeneous plasma with hot and cold areas. |
| | | Light emission of atoms (and stable molecules) 1-15 μs |
| | | after the laser pulse. |
| | | Plasma density and plasma temperature in equilibrium. |
| 3. | Material ablation and | Breakdown of molecules and clusters. |
| | plasma formation | Incomplete molecule breakdown and formation of CN, |
| | | C2, Ca O, etc. |
| | | Chemical reactions with ambient air. |
| | | Emission of element specific wavelengths. |
| | | Plasma density and plasma temperature control the |
| | | energy distribution in the excited S1 state and thus the |
| | | transition pathways to the ground state. |
| 4. | Plasma plume expansion | Self-broadening of emitting light peaks (Stark effect). |
| | | Cold atoms of the same light-emitting element absorb |
| | | their photons. Formation of a “dip” in the center of the |
| | | peak which have a Lorentzian distribution. |
| 5. | Collection of emitted | Delay time and integration time, nearly independent of |
| | light within a time gate | daylight. Light collection optics focused on plasma plume. |
| 6. | Qualitative view | Identification of an element by its emitting wavelengths. |
| | | Intensity of the individual peaks depending on the LIBS |
| | | setup and hardware. Generate identical spectra for a |
| | | given element by measuring reference spectra with the |
| | | same hardware and settings. |
| 7. | Quantitative view | Presentation of most elements with all their major |
| | | emitting wavelengths. Peak area and Lorentzian fit are |
| | | best options for quantitative aspects. |

The listed steps may start sequentially or in parallel. An important issue is how the laser energy converts to temperature. This depends strongly on the absorption conditions of the sample surface. Laser pulses typically generate a high temperature such that a plasma plume expands in a fast shock wave. Another hurdle is the inhomogeneous plasma plume, particularly in biological tissues. Hot and cold areas are influencing each other, for example by the Stark effect. The emission photons of the hot area will be absorbed by the same element in a colder area. This photon gets lost for detection, resulting in strong peak broadening and peak splitting. This leads also to a none linear calibration curve. All this is making LIBS of biological tissues often unpredictable. To overcome these difficulties, sometimes hundreds of laser shots will be averaged, to reduce the variability and to differentiate the different tissues. However, this works only if there is a homogeneous sample available. But biological tissue is based on cells, which are given a fine structure to the tissue and averaging may not the appropriate way to analyze.

In common LIBS systems it is difficult to control the applied process when biological tissues or samples need to be analyzed. For improving, the energy transfer from photon energy to a fast temperature increase may be considered. The absorption of light energy is based on the absorption coefficient of the involved molecules. But also on the density of the material, which will be ablated and generate the expanding plasma plume. Here the photon density or photon flux, which will be applied to the surface place an important rule. If the photon density is too high N and O from the ambient air will be analyzed too. If the density is too low, there will be not enough excited atoms for detection available. Therefore, a highly sensitive detector system is needed for collecting always enough light for a full spectrum. The next important step a homogeneous plasma plume. This succeeds only if the plasma plume has a given size with the appropriate particle density and with longer delay times between the analyzing laser pulse and the start of the gated spectrometer.

Some important items involved in LIBS analysis of biological tissues are: Correct photon density, i.e. avoid N and O emission light peaks from ambient air, which needs comparably low photon density, light break throughs in focus area in clean air should be prevented (this item can be addressed by a long focus lens, i.e. a long focus depth and a laser providing a homogenous beam profile, a low divergence and enough power for larger spot sizes); large laser spot size, for achieving enough signal and a homogenous plasma plume (again this item can be addressed by a long focus lens); highly sensitive collection of the emission light within 0 and 50 μs after the initial analyzing laser pulse, which needs a sensitive spectrometer, highest wavelength resolution is not necessary, an optical light collection from the top (with a long focus lens the expanding plasma plume will stay more or less within the focus cone of the lens); exact timing without jitter for having most constant conditions (fs to low ps accuracy); analyzing differences within a given element emission light pattern to acquire only pattern with the same or similar ratio. (Several ratios may be combined, wherein other elements may show similar effects. It is mainly based on the applied temperature); the biological tissue or sample may be pre-analyzed by probing over a given delay range for best conditions for the specific sample); for quantification and tissue differentiation the main emission light wavelength of a given element should be combined for a more stable result (Lorentzian fit may be used to calculate peak areas. In this way changes in the homogeneity of the plasma plume can be reduced); a hardware unit as control unit, which analyses acquired spectrum in real time and is able to make decisions for the upcoming laser shots in real time such as within a 10 Hz frame of the laser device (The control unit may have plural tasks: One is to exploit the acquired emission spectrum for quality control in real time. This can be done by a number of Ca emission lines which must be in a given ratio range to be accepted. All spectra out of this range will be discarded. Another task may be to decide about the need to apply cleaning, drying or drilling laser pulses in front of the next analytical LIBS laser pulse. The control unit may decide on the current acquired measured spectrum to stay on the current spot and to measure with the same or different conditions or to go to the next spot); Pre-evaluation of samples, i.e. before tissues differentiation starts, the control unit evaluates the sample by measuring the emission spectrum under a set of different setups or conditions; optimizing laser intensity, e.g., by flash lamp voltage and pulse length; determination of optimum delay time to a achieve a homogeneous signal; determining if clean-up or drying laser pulse is needed; and measuring H, O, N, Ca and Na emission lines (may involve peak fitting to receive typical peak parameters (Lorenzian)).

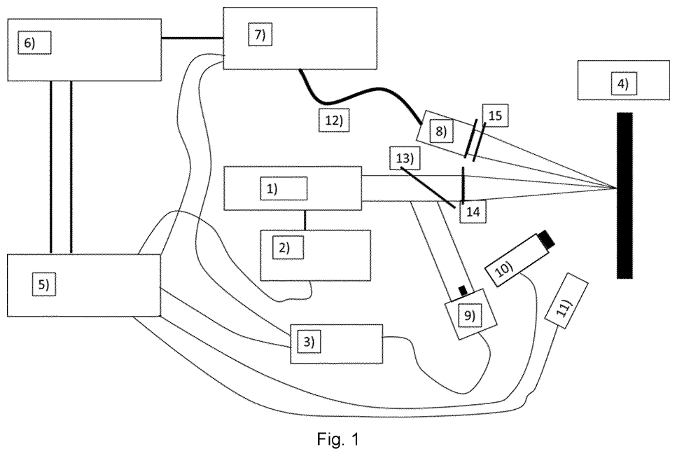

FIG. 1 shows an embodiment of a biological tissue analysis device according to the invention. The device comprises laser generator having a Nd:YAG, 1064 nm, 8 ns, 70 mJ, flash lamp pumped laser source 1 and laser controller 2. The laser generator is configured to provide laser beam pulses towards an XYZ stage 4 which is designed to hold or support a biological target tissue, also referred to as sample.

The biological tissue analysis device further comprises a spectrometer module having a gated spectrometer 7 configured to switch on and off within less than 1 ns, an emission light collecting system 8 and an optical fiber 12 connecting the spectrometer 7 and the emission light collecting system 8.

Further, the biological tissue analysis device comprises a delay time generator 4, fast photodiode trigger 9, a CCD camera 10, a microphone 11 as sound wave sensor and an optical system. The spectrometer 7, the laser controller 2, the delay time generator 3, the CCD camera 10 and the microphone 11 are connected to a computer 5 of a control unit which further comprises a plasma analyzing or temperature controller 6. The optical system comprises an emission or focusing lens 14 with a focal length of at least about 250 mm, and a converging or collective lens 15 as collective optics as well as a silica window 13 to generate a light reflex for the fast photodiode trigger 9.

The computer 5 is configured to operate the laser controller 2 to provide at least one laser beam pulse as analysis pulse directed towards the XYZ stage 4 and focused by the focusing lens 14. In operation, when hitting the target tissue arranged on the XYZ stage 4, the analysis pulse generates an analysis plasma at a laser pulse time. The analysis plasma comprises a reference element at least in a first excited state and in a second excited state. For example, when the target tissue is or comprises bone tissue, the reference element can be Ca, wherein the first and second excited stages are two different ionizations of Ca.

The emission light collecting system 8 is configured to collect, at an acquisition time, emission light of the analysis plasma via the collective lens 15 and to provide the collected emission light to the spectrometer 7 via the optical fiber 12. The spectrometer 7 is configured to analyze emission lines in the collected emission light and to communicate with the computer 5. Based on the data received from the spectrometer 7, the computer 5 together with the plasma temperature control unit 6 is configured to keep a reference emission line relationship between a first emission line of the reference element at a first wavelength, i.e. about 393 nm, correlating to the first excited state and a second emission line of the reference element at a second wavelength, i.e. about 422 nm, correlating to the second excited state inside a predefined reference emission line range.

The plasma analyzing or temperature controller 6 in interaction with the computer 5 to analyze and/or keep the emission line relationship in the predefined reference emission line range by adjusting the laser controller 2 and delay time generator 3 such that a plasma temperature of the analysis pulse is in a predefined temperature range and such that a plasma density of the analysis pulse is in a predefined density range.

More specifically, this is achieved selecting and discarding spectra, which fulfil or not fulfil predefined criteria. If background scattering occurs the delay time generator 3 adapts a delay time being the difference between the acquisition time and the laser pulse time. The delay time is set in accordance with a flat base line to be in a range of about 1 μs and 10 μs. The plasma temperature is corrected by Ca being the reference element. Moreover, the laser controller 2 is adjusted to adapt a power of the analysis pulse.

The microphone 11 is configured to record an acoustic shock wave of the analysis pulse provided to the target tissue. Moreover, the computer 5 is configured to receive the recorded acoustic shock wave from the microphone and to keep the recorded acoustic shock wave in a shock wave range by adapting a distance between the focusing lens 14 and the XYZ stage 4 and/or by adjusting a power of the laser via the laser controller 2.

For setting up the microphone 11, the computer is configured to position the focusing lens 14 and the XYZ stage relative to each other at plural distances, to activate the laser controller to induce the laser 1 to provide at least one analysis pulse at each of the plural distances, to receive the recorded acoustic shock wave from the microphone 11 for each of the plural distances, and positioning the focusing lens 14 and the XYZ stage 4 relative to each at the one of the plural distances complying to an intensity of the recorded acoustic shockwave.

For achieving clean and appropriate analysis results, the computer 5 is configured to operate the laser generator to provide a preparation pulse sequence less than 1 millisecond before each analysis pulse. The preparation pulse sequence can either be a comparably long laser pulse or a series of shorter laser pulses. A temporal width of the preparation pulse sequence is bigger than a temporal width of the analysis pulse.

When evaluating the spectral data received by the spectrometer, computer discards spectra having a maximum signal below a predefined value, discards spectra saturating the spectrometer module, discards spectra associated to air by analyzing emission peak intensities of N, of O, and/or of H, discards spectra generated outside a predefined plasma electron temperature and/or plasma electron density, and integrates peak areas of the emission lines.

The computer 5 and the plasma temperature control unit 6 are configured to apply the following procedure for spectrum control via plume configuration: In a first step, peaks of the defined emission lines of Ca are recognized and Lorentzian peak fitting and peak area calculation are performed. In a second step, measured ratios are compared by means of peak width and peak areas with quality criteria such as a sound signal recorded by the microphone 11. If the quality criteria are achieved the current measured spectrum is recorded and it is continued with the first step for a new analysis pulse. If the quality criteria are not achieved, in a third step reproducibility of key parameter is checked to be within a given range over a number of recorded spectra. Then it is moved to a new spot and a new analysis pulse is provided. In a fourth step, if a wet sample is recognized within the current spectrum the target tissue is dried by a preparation pulse sequence, a new analysis pulse is provided and it is continued at the first step. In a fifth step, poor sample conditions are recognized and delay time, laser power and photon density are changed to generate improved conditions.

For the biological tissue analysis device according to the invention and shown in FIG. 1, the following configuration aspects may be considered.

Photon density and photon flux: The recognition of the absorption behavior of a given target tissue is important in controlling the needed photon density for starting the spectrometric or LIBS process. From a single recorded LIBS spectrum, it is possible to identify meaning full and poor spectra. This can be done by the existents of intensive N and O emission lines and/or for from ratios of Ca or Na emission lines. The system can be adjusted in a way that the laser photon flux is just too low to do LIBS on the ambient air. The usage of long focus length offers the possibility that a larger spot size can be illuminated in a homogenous way, what is needed that the sample reached nearly the same temperature over the full spot area.

Emission light collection: The fast temperature increase of the sample spot area leads to the ablation of material within fast expansion plume. This can be detected by the acoustic shock wave. When the temperature induced breakdown and the electronical excitation of the atoms occurs the resulting plasma plume is still expanding. Therefore, the optical collecting system may need the potential to follow the moving plasma plume. The usage of a collection lens with a long focus point can keep the plasma plume for a comparably long period of time within the focus. But also, every emission light within a collection cone of the lens can be recorded. For the spectrometer, sensitivity is more important than wavelength resolution because the sensitivity is needed when the plasma plume is more expanded and more homogeneous, but having less excited atoms.

Laser spot size on target: With every laser shot a given volume can be ablated and analyzed. The volume is defined by the laser beam diameter and by the target material itself. Here material density and the absorbance coefficient may play major roles. Larger spot sizes offer the advantage to average over a given sample area. All cells and all extracellular liquid within this spot can be analyzed. Small spot sizes may be differed too much because of the inhomogeneity of biological samples. Additionally, a larger plasma plume stays longer and has more options to become more humogen by time. Vice versa, the plasma life time from small spot sizes may be short and only over a short period of time emission light can be recorded.

Timing: During the first micro second, continuous emission may occur just because of accelerated electrons. Within the next 2 μs to 30 μs it is possible to measure emission light from the expanding plasma plume. Because of the fast-changing conditions within the plasma plume it is important to measure always at the exact same time after the initial laser pulse occurs.

Emission line pattern: The emission light pattern of a given element can be determined by the number of excited states and by the number of potential ground states. All allowed transitions will give an emission line. There is a temperature dependent Boltzmann distribution who populate the potential excited states of the given element. Therefore, the specific emission line pattern of the element will be change, when the plasma temperature is changing.

Quantification: The usage of LIBS as a biomarker tool is only possible when an accurate element amount can be measured and can be compared. In general, a biomarker should recognize smallest differences within a study. This is only possible when the analytical method is reproducible, sensitive and accurate. Since every emission photon is related to a nucleus all major emission lines of a given element have to be measured. And as mentioned above, when the plasma temperature is changing also the individual emission lines may be changing. But the total number of emission photons of a given element may stay constant. Additionally, the Stark effect, a kind of self-broadening effect, leads sometimes to comparably broad peaks when high element concentrations are involved. This effect leads to underestimation of intensive peaks and to an overestimation of low abundant peaks. However, it should be noted that the number of involved atoms is always the same. Therefore, it is important to use a Lorentzian fit on the major emission lines (peaks) of a given element followed by the Lorentzian peak area for the determination of the element amount (combined peak areas of the given element).

Control unit: The control unit or system smart control unit (SSC) can analyze all incoming spectra for data quality (quality control (QC) in real time. It also does a sample evaluation for determining the best setup for data collection and tissue discrimination. Additionally, the system can decide when enough data points are recorded and the next spot should be taken. The SSC may do a Lorentzian peak fit on established emission lines and determines Peak area and peak width as main decision-making factors.

For the first setup (Delay setting): a time scan will be done with a changing delay times from 0.5 to 30 μs. The optimum setting is reached when there is nearly no N, O and H emission line. Also, total intensity and spectrum complexity may be a criterion. When the setup phase determines the optimum settings, then measuring phase starts.

For spectrum online quality control, the Ca emission lines, e.g., at 422 nm must be lower than the two 393 nm and 396 nm lines, or within a given range (ratio). Only if the criterion is fulfilled than the current spectrum will be acquired and the spectrum will be recorded. The elements C, H, N, O should be low or not existing or having a constant signal. The ratio of the Ca lines (393+396)/422 should be >0.6 and <1. Exact values may be determined during the pre-analyzing phase.

Also, other combinations may be used. From the acquired emission spectrum, the following elements can be assessed, for example: H 656 nm; Ca 393+396+422 nm; Na 589+819 nm; C 193 nm. This can be further supported by an intensive Na line at 819 nm. During the automated measurement the SSC unit is analyzing every acquired emission spectrum for reaching the quality criteria above.

After each laser shot the system can analyze spectra reproducibility with the criteria above, which should be within a given range. Depending also on the usage of clean-up, drying or drilling laser pulses. If the criteria are full filled the system starts with a new spot.

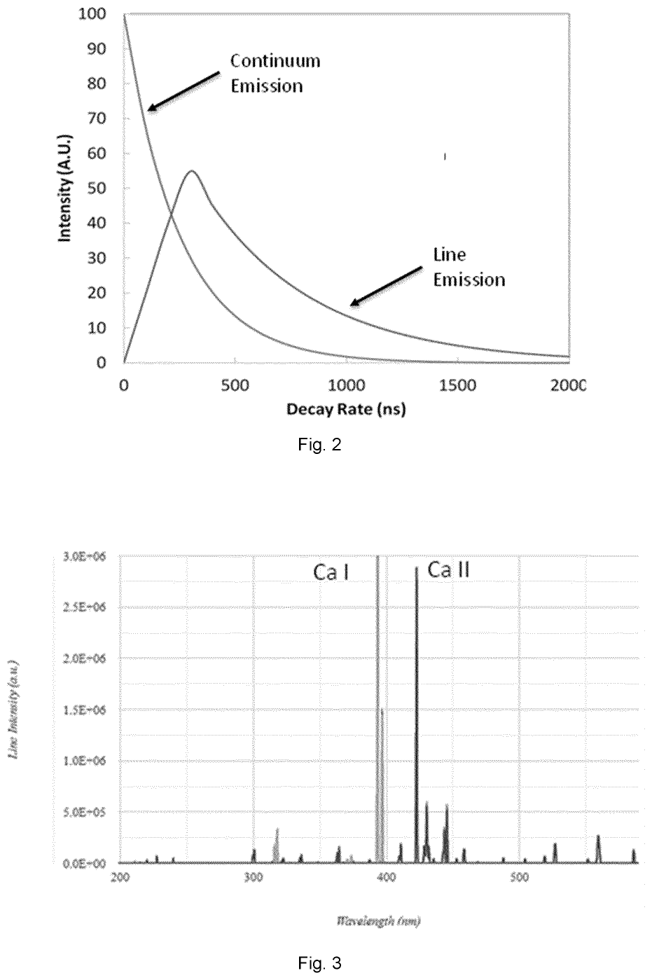

FIG. 2 schematically shows time evolution of an emission line of a possible reference element versus an emission line of a continuum, e.g., caused by ambient gas or air, in plasma generated by an analysis pulse. As can be seen, shortly after provision of the analysis pulse, the continuum emission line is comparably high or intense. At the same time the reference element emission line is comparably low. The older the continuum emission line is the lower or less intense it gets until it is about zero after about 1650 ns. Thus, at a delay time being the difference between the time where the analysis pulse is generated, i.e., the laser pulse time, and a time at which the spectroscope gathers the emission light, i.e., the acquisition time, of about 1650 ns essentially no continuum emission line is detectable.

In contrast, the reference element emission line first increases and afterwards more slowly decreases than the continuum emission line such that there still is a signal of the reference element emission light when the continuum emission light already is about zero.

Thus, at a delay time of about 1′650 ns the spectrum more or less only comprises the reference element emission light. Even though the signal at that stage is not at maximum it is essentially free from back scattering or the like. Thus, by using a sufficiently sensitive spectrometer the delay time can be adjusted to exclude any back scattering or the like.

In FIG. 3 fitting of Ca emission lines in a corticales sample as target tissue is shown. Calculation for Ca is performed at Te=2 eV and Ne=2.0e+21 cm−3. One line shows a minimum intensity, another line a maximum intensity over 20 analysis pulses, also referred to as shots. It shows, that the calculation can fit a given LIBS spectrum by adjusting the electron temperature and density. In this fit a plasma temperature of 23′200 K (Te=2 eV) was set. Only with this setting also the Ca I emission lines at 430.21 and 445.56 nm have the correct intensity. Thus, the spectra depicted in FIG. 3 comply as a ratio of the Ca I emission line and the Ca II emission line are in a predefined range.

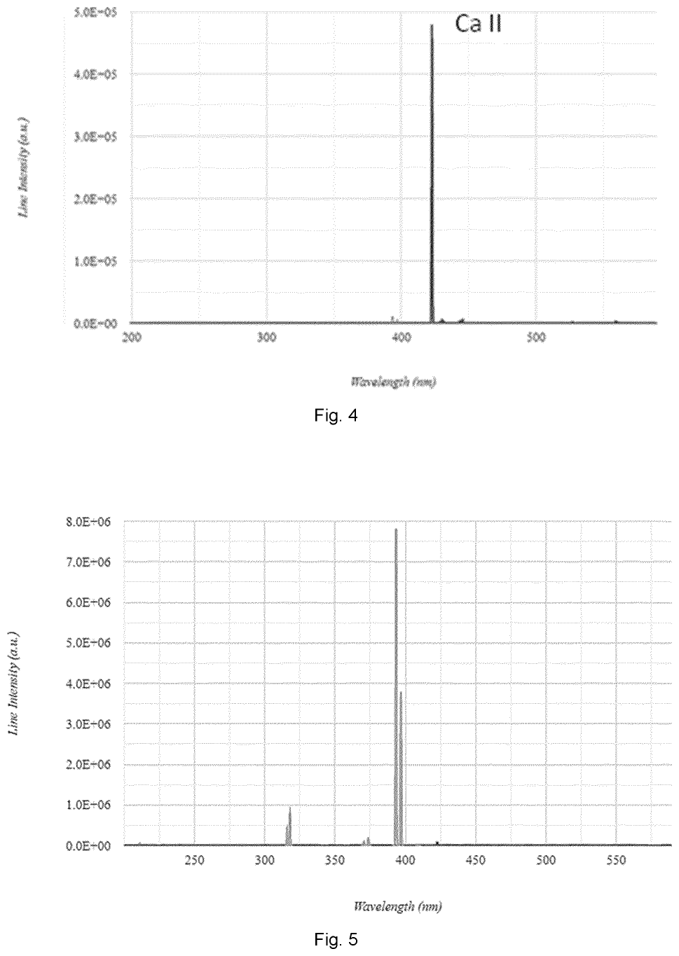

FIG. 4 and FIG. 5 show inappropriate situations. In particular, in FIG. 4 only a Ca II emission line can be detected at about 422 nm such that the ratio between the Ca I emission line and the Ca II emission line is not in the predefined range. Similarly, in FIG. 5 only the Ca I emission lines at about 393 nm and about 396 nm can be detected such that the ratio between the Ca I emission line and the Ca II emission line again is not in the predefined range. From the spectra of FIG. 4 and FIG. 5 it can be concluded that the plasma temperature and/or density is not suitable and has to be adjusted, e.g., by adapting a power of the laser beam generator. Furthermore, since the ratios of the spectra of FIG. 4 and FIG. 5 are identified as not being appropriate, they can be discarded from further evaluation or consideration.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

A computer program may be stored/distributed on a suitable medium, such as an optical storage medium or a solid-state medium supplied together with or as part of other hardware, but may also be distributed in other forms, such as via the Internet or other wired or wireless telecommunication systems. In particular, e.g., a computer program can be a computer program product stored on a computer readable medium which computer program product can have computer executable program code adapted to be executed to implement a specific method such as the method according to the invention. Furthermore, a computer program can also be a data structure product or a signal for embodying a specific method such as the method according to the invention.

1. A biological tissue analysis device to analyze biological tissue by laser induced breakdown spectroscopy, comprising:
a laser generator configured to provide laser beam pulses towards a biological target tissue and preferably comprising a high-power Q-switched Nd YAG laser;
a spectrometer module; and
a control unit connected to the laser generator and to the spectrometer module,
wherein the control unit is configured to operate the laser generator to provide at least one of the laser beam pulses as analysis pulse generating, at a laser pulse time, an analysis plasma comprising a reference element, e.g. Ca, at least in a first excited state and in a second excited state,
wherein the spectrometer module is configured to collect, at an acquisition time, emission light of the analysis plasma and to analyze emission lines in the collected emission light, and
wherein the control unit is configured to keep an emission line relationship between a first emission line of the reference element of the analysis plasma at a first wavelength correlating to the first excited state and a second emission line of the reference element of the analysis plasma at a second wavelength correlating to the second excited state in a predefined reference emission line range.

2. The biological tissue analysis device of claim 1, wherein the control unit is configured to keep the emission line relationship in the predefined reference emission line range by adjusting the laser generator and/or the spectrometer module such that a plasma temperature of the analysis plasma is in a predefined temperature range and such that a plasma density of the analysis plasma is in a predefined density range.

3. (canceled)

4. The biological tissue analysis device of claim 1, wherein the first wavelength is in a range of about 393 nanometer to about 397 nanometer, particularly about 393 nanometer or about 396 nanometer, and the second wavelength is in a range of about 422 nanometer to about 424 nanometer, particularly about 423 nanometer when the reference element is Ca.

5. The biological tissue analysis device of claim 1, wherein the emission line relationship is a ratio between the first emission line and the second emission line,
wherein the ratio between the first emission line and the second emission line preferably is a ratio between a sum of the emission lines at the first wavelength of about 393 and/or about 396 nanometer and the second wavelength of about 422 nanometer, when the reference element is Ca, wherein said ratio preferably is more than 0.6 and less than 1.

6. (canceled)

7. The biological tissue analysis device of claim 1, wherein the control unit is configured to keep the emission line relationship in the predefined reference emission line range and/or to eliminate back scattering by adapting a delay time being the difference between the acquisition time and the laser pulse time, wherein preferably
the laser generator is configured to provide a plurality of analysis pulses and the control unit is configured to evaluate the emission line relationship of each one of the plural analysis pulses and to adapt the delay time of subsequent analysis pulses to keep the emission line relationship in the predefined reference emission line range and/or to eliminate back scattering,
the delay time is in a range of about 0.5 microseconds to about 25 microseconds or in a range of about 2 microseconds and 10 microseconds, and/or
the control unit is configured to adapt the delay time in accordance with the reference element and/or back scattering.

8.-10. (canceled)

11. The biological tissue analysis device of claim 1, wherein the control unit is configured to keep the emission line relationship in the predefined reference emission line range by adapting a power of the analysis pulse and/or by adapting an integration time.

12. (canceled)

13. The biological tissue analysis device of claim 1, wherein the laser generator has a beam directing optics configured to focus the plural laser beam pulses,
wherein preferably the beam directing optics of the laser generator
has an emission lens with a focal length of at least about 50 millimeter, of at least about 400 millimeter, or in a range of about 150 millimeter to about 250 millimeter,
is configured to generate a laser beam with a spot diameter in a range of about 0.1 millimeter to about 0.4 millimeter, and/or
is configured to generate a laser beam with a depth of focus of more than 10 millimeter.

14.-16. (canceled)

17. The biological tissue analysis device of claim 1, wherein the spectrometer module has a converging lens, wherein the analysis pulse has a focal point and wherein the converging lens of the spectrometer module is arranged in a projection of a conus having its apex at the focal point of the analysis pulse and having a cone angle of less than about 60° and preferably of about 30° or of about 11°.

18. The biological tissue analysis device of claim 1, comprising
a sound wave sensor configured to record an acoustic shock wave of the analysis pulse provided to the target tissue, wherein the sound wave sensor is connected to the control unit, and/or
a light collecting optics configured to direct light towards the spectrometer module.

19. The biological tissue analysis device of claim 17, comprising a sound wave sensor configured to record an acoustic shock wave of the analysis pulse provided to the target tissue, wherein the sound wave sensor is connected to the control unit,
wherein the control unit is configured to receive the recorded acoustic shock wave from the sound wave sensor, and
wherein the control unit is configured to keep the recorded acoustic shock wave in a shock wave range by adapting a distance between the beam directing optics and the target tissue, by adapting a focal point of the beam directing optics, and/or by adjusting a power of the laser generator, and
wherein the control unit preferably is configured to determine a quality by an acoustic shock wave from the sound wave sensor.

20. The biological tissue analysis device of claim 18,
wherein the control unit is configured to position the beam directing optics and the target tissue relative to each other at plural distances, to activate the laser generator to provide at least one analysis pulse at each of the plural distances, to receive the recorded acoustic shock wave from the sound wave sensor for each of the plural distances, and positioning the beam directing optics and the target tissue at the one of the plural distances complying to a selection criterion,
wherein the selection criterion preferably is a height of an intensity of the recorded acoustic shockwave, and
wherein the control unit preferably is configured to determine a quality by an acoustic shock wave from the sound wave sensor.

21.-23. (canceled)

24. The biological tissue analysis device of claim 1, wherein the spectrometer module
is configured to switch on within one nanosecond or less and to switch off within one nanosecond or less,
has a spectrometer board and wherein the control unit is embodied on the spectrometer board, and/or
comprises a gated spectrometer.

25.-26. (canceled)

27. The biological tissue analysis device of claim 1, wherein the control unit is configured to operate the laser generator to provide at least one of the laser beam pulses as preparation pulse sequence, wherein preferably
a temporal width of the preparation pulse sequence is bigger than a temporal width of the analysis pulse,
the control unit is configured to operate the laser generator to provide the analysis pulse less than 1 millisecond, less than 1 microsecond, less than 100 nanoseconds or less than 50 nanoseconds after the preparation pulse sequence.

28.-29. (canceled)

30. The biological tissue analysis device of claim 1, wherein the control unit is configured to evaluate spectral data provided by the spectrometer module, wherein evaluation of the spectral data comprises at least one of:
discarding spectra having a maximum signal below a predefined value;
discarding spectra saturating the spectrometer module;
discarding spectra associated to air by analyzing emission peak intensities of N, of O, and/or of H;
discarding spectra generated outside a predefined plasma electron temperature and/or plasma electron density;
filtering inappropriate spectra; and
summing up or integrating peak areas of the emission lines.

31. (canceled)

32. The biological tissue analysis device of claim 1, comprising a xyz-stage, wherein the xyz-stage is configured to support a sample of biological tissue at a predefined position and to move the sample in an x-direction, in a y-direction perpendicular to the x-direction and in a z-direction perpendicular to the x-direction and the y-direction.

33. A method of detecting cells of a specific type such as cancer in a biological target tissue, comprising:
a laser generator, preferably comprising a high-power Q-switched Nd YAG laser, providing laser beam pulses towards the target tissue, wherein at least one of the laser beam pulses is configured as analysis pulse generating, at a laser pulse time, an analysis plasma comprising a reference element at least in a first excited state and in a second excited state, wherein the reference element preferably is Ca; and
a spectrometer module, preferably comprising a gated spectrometer collecting emission light of the analysis plasma at an acquisition time and analyzing emission lines in the collected emission light;
wherein keeping an emission line relationship between a first emission line of the reference element of the analysis plasma at a first wavelength correlating to the first excited state and a second emission line of the reference element of the analysis plasma at a second wavelength correlating to the second excited state in a predefined reference emission line range, wherein the emission line relationship preferably is a ration between the first emission line and the second emission line.

34. The method of claim 33, wherein the emission line relationship is kept in the predefined reference emission line range by adjusting the laser generator and/or the spectrometer module such that a plasma temperature of the analysis plasma is in a predefined temperature range and such that a plasma density of the analysis plasma is in a predefined density range.

35. (canceled)

36. The method of claim 33, wherein the first wavelength is about 393 nanometer or about 396 nanometer and the second wavelength is about 423 nanometer when the reference element is Ca,
wherein the predefined reference emission line range preferably is a ratio between a sum of the emission lines at the first wavelength of about 393 nanometer and the second wavelength of about 423 nanometer, when the reference element is Ca, wherein said ratio preferably is more than 0.6 and less than 1.

37.-38. (canceled)

39. The method of claim 33, wherein the emission line relationship is kept in the predefined reference emission line range and/or back scattering is eliminated by adapting a delay time being the difference between the acquisition time and the laser pulse time, wherein preferably
the laser generator provides a plurality of analysis pulses, wherein the emission line relationship of each one of the plural analysis pulses is evaluated and wherein the delay time of subsequent analysis pulses is adapted to keep the emission line relationship in the predefined reference emission line range and/or to eliminate back scattering,
the delay time is in a range of about 0.5 microseconds to about 25 microseconds or in a range of about 2 microseconds and 10 microseconds, and/or
the delay time is in a range of about 0.5 microseconds to about 25 microseconds or in a range of about 2 microseconds and 10 microseconds, and/or
the delay time is adapted in accordance with the reference element and/or back scattering.

40.-42. (canceled)

43. The method of claim 33, wherein the emission line relationship is kept in the predefined reference emission line range by adapting a power of the analysis pulse and/or by adapting an integration time, and/or
wherein at least one of the laser beam pulses is provided as preparation pulse sequence, wherein preferably a temporal width of the preparation pulse sequence is bigger than a temporal width of the analysis pulse, and/or the analysis pulse is provided less than 10 nanoseconds after the preparation pulse sequence.

44. (canceled)

45. The method of claim 33, wherein the laser generator focuses the plural laser beam pulses,
wherein the plural laser beam pulses preferably have a focal length of at least about 50 millimeter, of at least about 400 millimeter, or in a range of about 150 millimeter to about 250 millimeter,
wherein the beam pulses have a spot diameter in a range of about 0.1 millimeter to about 0.4 millimeter, and/or
wherein the beam pulses have a depth of focus of more than 10 millimeter.

46.-48. (canceled)

49. The method of claim 33, wherein a sound wave sensor records an acoustic shock wave of the analysis plasma generated by the analysis pulse provided to the target tissue, wherein preferably a quality is determined by an acoustic shock wave from the sound wave sensor, and
wherein the method preferably comprises
keeping the recorded acoustic shock wave in a shock wave range by adapting a distance between the laser generator and the target tissue, by adapting a focal point of the laser generator or by adjusting a power of the laser generator, and/or
positioning the laser generator and the target tissue relative to each other at plural distances, activating the laser generator to provide at least one analysis pulse at each of the plural distances, the sound wave sensor recording an acoustic shock wave for each of the plural distances, and positioning the laser generator and the target tissue relative to each at the one of the plural distances complying to a selection criterion, and
wherein the selection criterion preferably is a height of an intensity of the recorded acoustic shockwave.

50.-58. (canceled)

59. The method of claim 33, wherein spectral data provided by the spectrometer module is evaluated, wherein evaluation of the spectral data comprises at least one of:
discarding spectra having a maximum signal below a predefined value;
discarding spectra saturating the spectrometer module;
discarding spectra associated to air by analyzing emission peak intensities of N, of O, and/or of H; and
discarding spectra generated outside a predefined plasma electron temperature and/or plasma electron density;
filtering inappropriate spectra; and
summing up or integrating peak areas of the emission lines.

60.-61. (canceled)

62. A computer program comprising instructions which, when the program is executed by a computer, cause the computer to carry out the method of claim 33.
